(19) United States
(12) Patent Application Publication
(10) Pub. No.: US 2019/0351774 A1
(43) Pub. Date: Nov. 21, 2019

(54) POWER TRANSFER SYSTEM AND METHOD

(71) Applicant: Delphi Technologies, LLC, Troy, MI (US)

(72) Inventors: Nicholas J. Brown, North Huntingdon, PA (US); Gary R. Thompson, Warren, OH (US); Patrick J. Bollinger, Warren, OH (US)

(21) Appl. No.: 15/980,024

(22) Filed: May 15, 2018

(51) Int. Cl. B60L 11/18; H02J 50/90; H02J 50/10; H02J 7/02; H01F 38/14

(52) U.S. Cl. CPC B60L 11/1831; H02J 50/90; B60L 11/182; H01F 38/14; H02J 50/10; H02J 7/025; B60L 11/1833

(57) ABSTRACT

A power transfer system includes a positioning-device, a base-coil, and one or more controller-circuits. The positioning-device determines a position of a vehicle moving within a power-transfer-zone. The base-coil is disposed within the power-transfer-zone and emits a magnetic-field in response to electrical power applied to the base-coil. The one or more controller-circuits are in communication with the positioning-device and the base-coil. The positioning-device determines whether any portion of the vehicle overlays the base-coil. The one or more controller-circuits immediately control the electrical power applied to the base-coil such that the base-coil emits the magnetic-field characterized as having value of greater than 27 microteslas, when any portion of the vehicle overlays the base-coil.

### TECHNICAL FIELD OF INVENTION

This disclosure generally relates to power transfer system, and more particularly relates to power transfer system for charging an electric vehicle.

### BRIEF DESCRIPTION OF DRAWINGS

The present invention will now be described, by way of example with reference to the accompanying drawings, in which:

FIG. 1 is an illustration of a power transfer system in accordance with one embodiment;

FIG. 2 is another illustration of the power transfer system of FIG. 1 in accordance with one embodiment;

FIG. 3 is a side view of the power transfer system of FIG. 2 in accordance with one embodiment; and

FIG. 4 is an illustration of a method of operating the power transfer system of FIG. 1 accordance with another embodiment.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

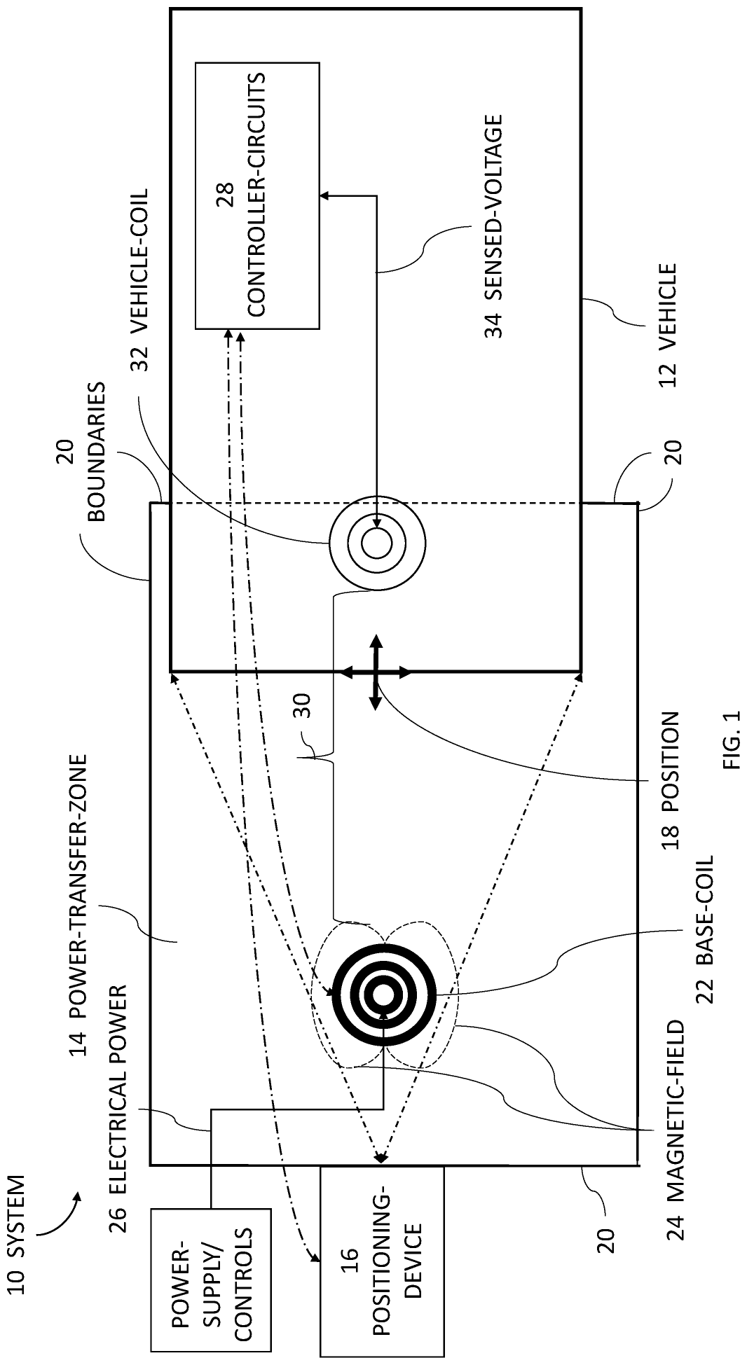

FIG. 1 is an illustration of a power transfer system 10, hereafter referred to as the system 10. As will be described in more detail below, the system 10 is an improvement over other power transfer systems, because the system 10 increases a sensing-range of a vehicle 12 in a power-transfer-zone 14.

The system 10 includes a positioning-device 16 that is configured to determine a position 18 of the vehicle 12 moving within the power-transfer-zone 14. In the example illustrated in FIG. 1, the positioning-device 16 is remotely mounted (e.g. on a pedestal or a wall) and determines the position 18 of the vehicle 12 relative to boundaries 20 of the power-transfer-zone 14. The positioning-device 16 may be any positioning-device 16 suitable to detect the position 18 of the vehicle 12. One such positioning-device 16 is the LEDDAR® IS16, marketed by LeddarTech Inc. of Quebec City, Quebec, Canada.

The system 10 also includes a base-coil 22 disposed within the power-transfer-zone 14 configured to emit a magnetic-field 24 in response to electrical power 26 applied to the base-coil 22. The base-coil 22 (also referred to as a ground-coil or ground-assembly), may be any base-coil 22 suitable for transferring energy to the vehicle 12 and preferably conforms to an SAE Recommended Practice J2954 NOV2017 specification. The base-coil 22 includes a power-supply and corresponding control-devices required to generate the magnetic-field 24. In general, a strength of the magnetic-field 24 increases with increasing electrical power 26 applied to the base-coil 22. Additionally, the strength of the magnetic-field 24 is greatest proximate to the base-coil 22, and generally varies inversely with the third-power of distance away from the base-coil 22.

The system 10 also includes one or more controller-circuits 28 in communication with the positioning-device 16 and the base-coil 22. As illustrated in FIG. 1, the one or more controller-circuits 28 are installed on the vehicle 12 and are in wireless communication (e.g. using IEEE 802.11, cellular, dedicated short range communication (DSRC), and/or BLUETOOTH®, etc. protocols) with the positioning-device 16 and the base-coil 22. In another embodiment not shown, the one or more controller-circuits 28 are distributed among the vehicle 12, the positioning-device 16, and the base-coil 22 and are in wireless communication with one another. The one or more controller-circuits 28 may include a processor (not shown) such as a microprocessor or other control circuitry such as analog and/or digital control circuitry including an application specific integrated circuit (ASIC) for processing data as should be evident to those in the art. The one or more controller-circuits 28 may include a memory (not shown), including non-volatile memory, such as electrically erasable programmable read-only memory (EEPROM) for storing one or more routines, threshold values, and captured data. The one or more routines may be executed by the processor to perform steps for determining the position 18 and the magnetic-field 24 based on signals received by the one or more controller-circuits 28 from the positioning-device 16 and the base-coil 22, as described herein. The one or more controller-circuits 28 control the electrical power 26 applied to the base-coil 22 by controlling a voltage across the base-coil 22, or in another embodiment, by controlling a current through the base-coil 22. The one or more controller-circuits 28 control a rate of the electrical power 26 applied to the base-coil 22 characterized by a linear-function (includes both step-function and linear-ramp), or in another embodiment characterized by a polynomial-function.

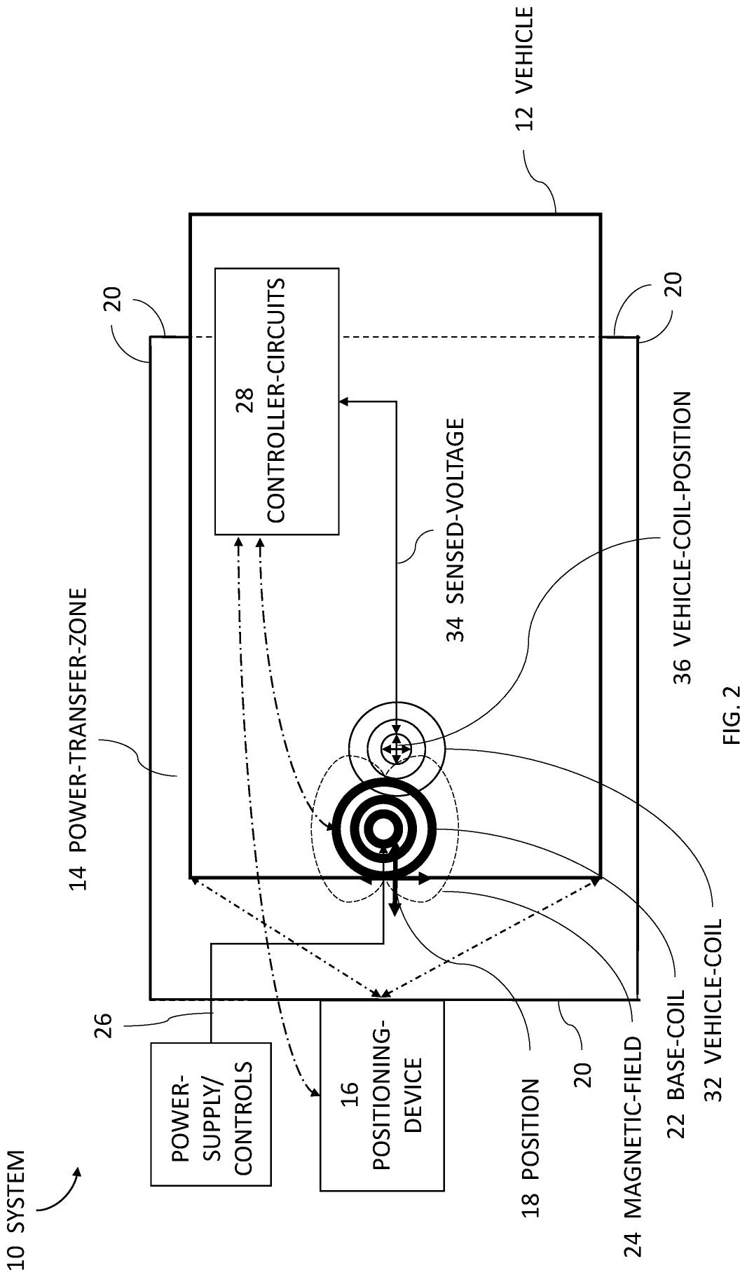

FIG. 2 illustrates the vehicle 12 moving toward the base-coil 22 within the power-transfer-zone 14. The positioning-device 16 determines whether any portion of the vehicle 12 overlays the base-coil 22. That is, the positioning-device 16 determines whether a footprint, border, or vertical projection of the vehicle 12 completely covers the base-coil 22 such that no other object occupies the space directly above the entirety of the base-coil 22. In accordance with the determination that any portion of the vehicle 12 overlays the base-coil 22, the one or more controller-circuits 28 control the electrical power 26 applied to the base-coil 22 such that the base-coil 22 emits the magnetic-field 24 characterized as having a value of greater than 27 microteslas (27 μT). An exposed base-coil 22 is typically limited to a magnetic-field 24 with a maximum strength of 15 μT, based on an International Commission on Non-Ionizing Radiation Protection 2010 (ICNIRP 2010) safety limit for implanted electronic pacemakers. Prior art power transfer systems typically require the vehicle-coil 32 to be aligned with the base-coil 22 for optimum power transfer before increasing the strength of the magnetic-field 24 of the base-coil 22. This requirement to limit the strength of the magnetic-field 24 results in the vehicle-coil 32 initially coupling with base-coil 22 at a distance less than approximately 300 mm, due to the relatively low strength of magnetic-field 24 of 15 μT. By increasing the strength of the magnetic-field 24 to greater than 27 μT, the system 10 enables an increase in a sensing-distance 30 from the base-coil 22 in excess of 300 mm.

The system 10 further includes a vehicle-coil 32 installed on the vehicle 12 and in communication with the one or more controller-circuits 28. The vehicle-coil 32 (also referred to as a vehicle-assembly) may be any vehicle-coil 32 suitable for receiving energy from the base-coil 22, and preferably conforms to the SAE Recommended Practice J2954 NOV2017 specification. In the examples illustrated in FIGS. 1-2, the vehicle-coil 32 is hard-wired to the one or more controller-circuits 28 on the vehicle 12. In another embodiment the vehicle-coil 32 is in wireless communication with the one or more controller-circuits 28 installed on the vehicle 12 and/or distributed among the vehicle 12, the positioning-device 16, and the base-coil 22. The vehicle-coil 32 generates a sensed-voltage 34 in response to the strength of the magnetic-field 24 emitted by the base-coil 22. In other words, the vehicle-coil 32 couples with the base-coil 22 when the vehicle-coil 32 is within the sensing-distance 30 and generates the sensed-voltage 34 based on the strength of the magnetic-field 24. As used herein, the sensing-distance 30 is the distance between the magnetic-field 24 and the vehicle-coil 32 where the vehicle-coil 32 is enabled to generate the sensed-voltage 34 above a voltage-threshold. Testing by the inventors has discovered the voltage-threshold in a range from 0.5V to 0.7V is indicative of reliable sensing of the magnetic-field 24 by the vehicle-coil. The coupling of the vehicle-coil 32 with the base-coil 22 is important in determining whether the vehicle-coil 32 is positioned for optimum power transfer.

In another embodiment, the one or more controller-circuits 28 further control the electrical power 26 applied to the base-coil 22 based on a vehicle-coil-position 36 (see FIG. 2) within the power-transfer-zone 14 when the vehicle 12 overlays the base-coil 22. The vehicle-coil-position 36 on the vehicle 12 is communicated by the one or more controller-circuits 28 to the base-coil 22 and the electrical power 26 applied to the base-coil 22 is increased until the sensed-voltage 34 is greater than the voltage-threshold.

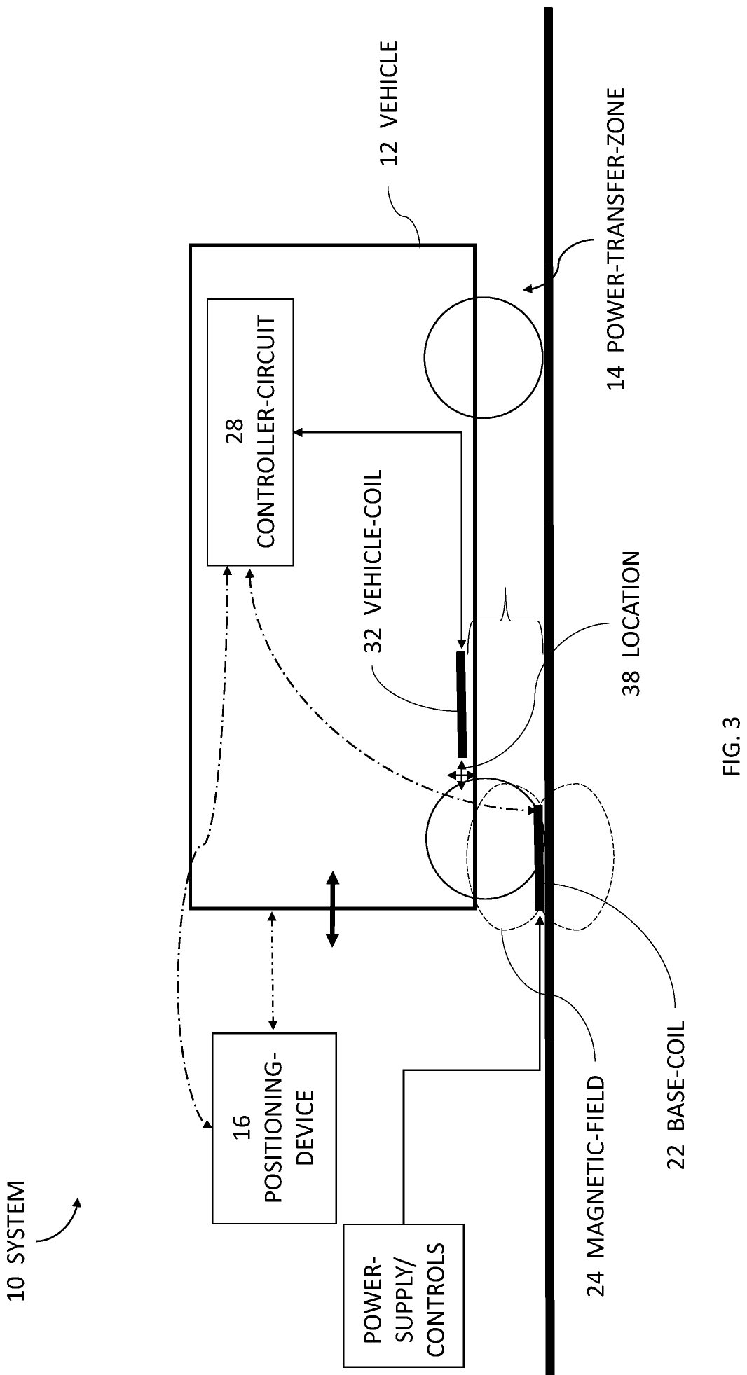

FIG. 3 is a side view of the vehicle 12 positioned within the power-transfer-zone 14 and overlaying the base-coil 22. The one or more controller-circuits 28 further control the electrical power 26 applied to the base-coil 22 based on a location 38 of the vehicle-coil 32 on the vehicle 12 when the vehicle 12 overlays the base-coil 22. The location 38 adds a height above the ground (i.e. includes a Z-axis component) of the vehicle-coil 32 in addition to a placement on the vehicle 12 relative to the vehicle 12 footprint. The location 38 of the vehicle-coil 32 is critical for the system 10 to determine the optimum power transfer requirements for the vehicle 12.

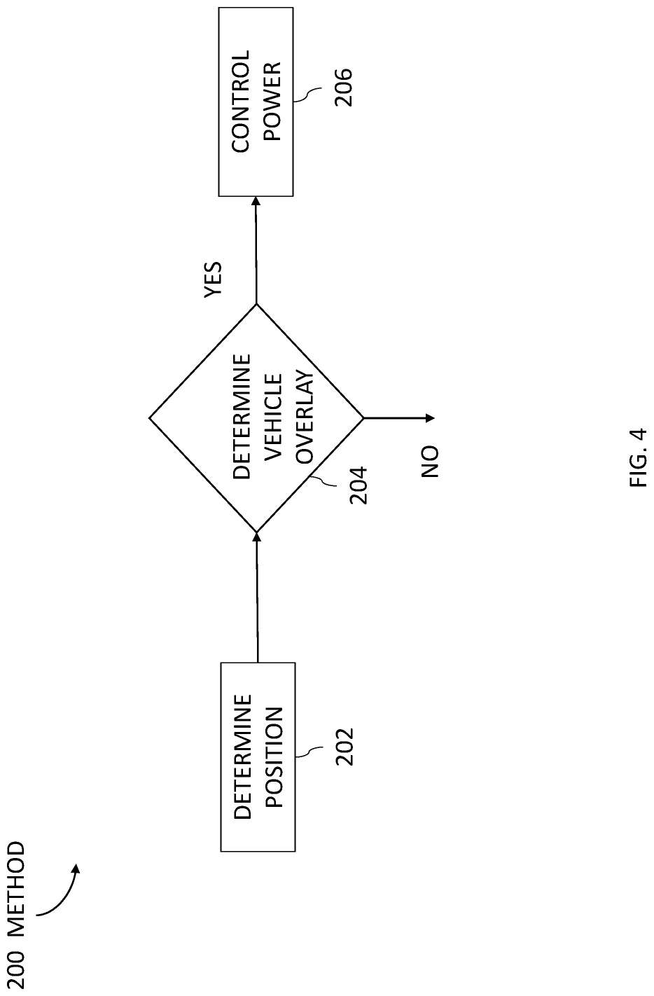

FIG. 4 is a flow chart of another embodiment of a method 200 of operating a power transfer system 10, hereafter referred to as the system 10.

Step 202, DETERMINE POSITION, includes determining a position 18 of a vehicle 12 moving within a power-transfer-zone 14 with a positioning-device 16 as described above.

Step 204, DETERMINE VEHICLE OVERLAY, includes determining, with the positioning-device 16, whether any portion of the vehicle 12 overlays a base-coil 22 disposed within the power-transfer-zone 14 as described above.

Step 206, CONTROL POWER, includes controlling electrical power 26 applied to the base-coil 22, with one or more controller-circuits 28 in communication with the positioning-device 16 and the base-coil 22, such that the base-coil 22 immediately emits a magnetic-field 24 characterized as having value of greater than 27 microteslas (27 μT) as described above. The system 10 further includes a vehicle-coil 32 installed on the vehicle 12 and in communication with the one or more controller-circuits 28 that generates a sensed-voltage 34 in response to the magnetic-field 24 emitted by the base-coil 22. The one or more controller-circuits 28 may control the electrical power 26 to the base-coil 22 based on a vehicle-coil-position 36 within the power-transfer-zone 14 when the vehicle 12 overlays the base-coil 22. The one or more controller-circuits 28 may also control the electrical power 26 to the base-coil 22 such that the vehicle-coil 32 generates the sensed-voltage 34 in a range of 0.5V-0.7V. The one or more controller-circuits 28 may control the electrical power 26 to the base-coil 22 based on a location 38 of the vehicle-coil 32 on the vehicle 12. The one or more controller-circuits 28 may control the electrical power 26 applied to the base-coil 22 by controlling a voltage across the base-coil 22, or by controlling a current through the base-coil 22. The one or more controller-circuits 28 may control a rate of the electrical power 26 applied to the base-coil 22 characterized by a linear-function, or characterized by a polynomial-function.

Accordingly, a power transfer system 10 (the system 10), and a method 200 of operating the system 10 are provided. The system 10 is an improvement over prior art power transfer systems because the system 10 increases the sensing-distance 30 between the base-coil 22 and the vehicle-coil 32 without creating a safety hazard of the exposed base-coil 22.

While this invention has been described in terms of the preferred embodiments thereof, it is not intended to be so limited, but rather only to the extent set forth in the claims that follow. “One or more” includes a function being performed by one element, a function being performed by more than one element, e.g., in a distributed fashion, several functions being performed by one element, several functions being performed by several elements, or any combination of the above. It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact. The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context. Directional terms such as top, bottom, upper, lower, left, right, front, rear, etc. do not denote any particular orientation, but rather these directional terms are used to distinguish one element from another and establish a relationship between the various elements.

We claim:

1. A power transfer system, said system comprising:
a positioning-device, the positioning-device determining a position of a vehicle moving within a power-transfer-zone;
a base-coil disposed within the power-transfer-zone, the base-coil emitting a magnetic-field in response to electrical power applied to the base-coil; and
one or more controller-circuits in communication with the positioning-device, and the base-coil:
wherein the positioning-device determines whether any portion of the vehicle overlays the base-coil,
in accordance with the determination that any portion of the vehicle overlays the base-coil, the one or more controller-circuits immediately control the electrical power applied to the base-coil such that the base-coil emits the magnetic-field characterized as having value of greater than 27 microteslas.

2. The system in accordance with claim 1, wherein the system further includes a vehicle-coil installed on the vehicle, the vehicle-coil in communication with the one or more controller-circuits,
the vehicle-coil generating a sensed-voltage in response to the magnetic-field emitted by the base-coil,
whereby the one or more controller-circuits further control the electrical power applied to the base-coil based on a vehicle-coil-position within the power-transfer-zone when the vehicle overlays the base-coil.

3. The system in accordance with claim 2, wherein the one or more controller-circuits control the electrical power applied to the base-coil such that the vehicle-coil generates the sensed-voltage in a range of 0.5V-0.7V when the vehicle overlays the base-coil.

4. The system in accordance with claim 2, wherein the one or more controller-circuits further control the electrical power applied to the base-coil based on a location of the vehicle-coil on the vehicle when the vehicle overlays the base-coil.

5. The system in accordance with claim 1, wherein the one or more controller-circuits further control the electrical power applied to the base-coil by controlling a voltage across the base-coil.

6. The system in accordance with claim 1, wherein the one or more controller-circuits further control the electrical power applied to the base-coil by controlling a current through the base-coil.

7. The system in accordance with claim 1, wherein the one or more controller-circuits further control a rate of the electrical power applied to the base-coil, the rate characterized by a linear-function.

8. The system in accordance with claim 1, wherein the one or more controller-circuits further control a rate of the electrical power applied to the base-coil, the rate characterized by a polynomial-function.

9. A method of operating a power transfer system, said method comprising:
determining a position of a vehicle moving within a power-transfer-zone with a positioning-device;
emitting a magnetic-field, with a base-coil disposed within the power-transfer-zone, in response to electrical power applied to the base-coil;
determining whether any portion of the vehicle overlays the base-coil with the positioning-device; and
controlling the electrical power applied to the base-coil, with one or more controller-circuits in communication with the positioning-device and the base-coil, such that the base-coil immediately emits the magnetic-field characterized as having value of greater than 27 microteslas in accordance with the determination that any portion of the vehicle overlays the base-coil.

10. The method in accordance with claim 9, wherein the system further includes a vehicle-coil installed on the vehicle, the vehicle-coil in communication with the one or more controller-circuits,
the vehicle-coil generating a sensed-voltage in response to the magnetic-field emitted by the base-coil,
the method further including the step of controlling the electrical power applied to the base-coil, with the one or more controller-circuits, based on a vehicle-coil-position within the power-transfer-zone when the vehicle overlays the base-coil.

11. The method in accordance with claim 10, further including the step of controlling the electrical power applied to the base-coil, with the one or more controller-circuits, such that the vehicle-coil generates the sensed-voltage in a range of 0.5V-0.7V when the vehicle overlays the base-coil.

12. The method in accordance with claim 10, further including the step of controlling the electrical power applied to the base-coil, with the one or more controller-circuits, based on a location of the vehicle-coil on the vehicle when the vehicle overlays the base-coil.

13. The method in accordance with claim 9, further including the step of controlling the electrical power applied to the base-coil, with the one or more controller-circuits, by controlling a voltage across the base-coil.

14. The method in accordance with claim 9, further including the step of controlling the electrical power applied to the base-coil, with the one or more controller-circuits, by controlling a current through the base-coil.

15. The method in accordance with claim 9, further including the step of controlling a rate of the electrical power applied to the base-coil, with the one or more controller-circuits, the rate characterized by a linear-function.

16. The method in accordance with claim 9, further including the step of controlling a rate of the electrical power applied to the base-coil, with the one or more controller-circuits, the rate characterized by a polynomial-function.

17. A power transfer system, said system comprising:
a positioning-device;
a base-coil; and
one or more controller-circuits in communication with the positioning-device and the base-coil, wherein when any portion of a vehicle overlays the base-coil, the one or more controller-circuits immediately applies electrical power to the base-coil such that the base-coil emits a magnetic-field characterized as having value of greater than 27 microteslas.
